(19) United States
(12) Patent Application Publication
(10) Pub. No.: US 2007/0241511 A1
(43) Pub. Date: Oct. 18, 2007

(54) COMPACT MECHANICAL SEAL

(76) Inventor: Han-Sik Kim, Gimpo-Si (KR)

Correspondence Address: IPLA P.A., 3580 WILSHIRE BLVD., 17TH FLOOR, LOS ANGELES, CA, 90010, US

(21) Appl. No.: 11/463,104

(22) Filed: Aug. 8, 2006

(30) Foreign Application Priority Data
Apr. 18, 2006 (KR) 20-2006-0010367

(51) Int. Cl. F16J 15/34

(52) U.S. Cl. 277/358

(57) ABSTRACT

A mechanical seal having a compact structure is disclosed. The mechanical seal includes a stationary seal part fitted around a rotary shaft such that the stationary seal part is maintained in a stationary state when the rotary shaft rotates, and a rotary seal part sealably fitted around the rotary shaft such that the rotary seal part is rotated together with the rotary shaft when the rotary shaft rotates. The rotary seal part has an annular rotary seal face being in close contact with a stationary seal face of the stationary seal part in a state of being elastically pressed against each other during the rotation of the rotary shaft. The rotary seal part does not frictionally contact with the rotary shaft, so that it is not worn. Accordingly, the mechanical seal can be reliably used for a prolonged period of time.

### CROSS REFERENCE

Applicant claims foreign priority under Paris Convention and 35 U.S.C. § 119 to a Korean Patent Application No. 10-2006-0010367, filed Apr. 18, 2006 with the Korean Intellectual Property Office.

### BACKGROUND OF THE INVENTION

1. Field of the Invention

The present invention relates to a mechanical seal for preventing oil from being leaked along a rotary shaft, in particular, a gap defined between the rotary shaft and a bearing fitted around the rotary shaft, in various machines, rotary machines, gear boxes, spindles, machine tools, water pumps, oil pumps, fans, mills, rollers, and mixers. In particular, the present invention relates to a mechanical seal having a compact structure so that it can be installed in a limited space while obtaining an enhanced sealing effect.

2. Description of the Related Art

Referring to FIG. 5, a conventional oil seal is illustrated. As shown in FIG. 5, the conventional oil seal includes a rubber lip and a spring. The rubber lip is fitted around a rotary shaft while being in close contact with the circumferential surface of the rotary shaft by a pressing force of the spring. Since the rubber lip directly contacts the rotary shaft in the conventional oil seal, the rubber lip and rotary shaft may be worn. As a result, there are drawbacks of oil leakage and shortened lift span. A mechanical seal can eliminate such drawbacks incurred in the conventional oil seal. However, conventional mechanical seals have a drawback of an increased installation space.

### SUMMARY OF THE INVENTION

The present invention has been made in view of the above-mentioned problems incurred in the related art, and an object of the invention is to provide a mechanical seal having a compact structure so that it can be installed in a limited space while obtaining an enhanced sealing effect.

Another object of the invention is to provide a mechanical seal having a structure in which there is no portion frictionally contacting a rotating shaft, on which the mechanical seal is installed, thereby being capable of preventing wear of the mechanical seal, and thus, preventing oil leakage caused by wear of the mechanical seal, and achieving extension of life span.

In one aspect, the present invention provides a compact mechanical seal comprising: a stationary seal part fitted around a rotary shaft such that the stationary seal part is maintained in a stationary state when the rotary shaft rotates, the stationary seal part having an annular stationary seal face; and a rotary seal part sealably fitted around the rotary shaft such that the rotary seal part is rotated together with the rotary shaft when the rotary shaft rotates, the rotary seal part having an annular rotary seal face being in close contact with the stationary seal face of the stationary seal part in a state of being elastically pressed against each other during the rotation of the rotary shaft.

The stationary seal part may comprise an oil seal cover mounted to a bearing housing fitted around the rotary shaft, a rubber packing fixed to an inner surface of the oil seal cover, and a stationary seal ring fixed to the rubber packing, the stationary seal ring providing the annular stationary seal face.

The rotary seal part may comprise a sleeve tightly fitted around the rotary shaft, a spring support fixed to one end of the sleeve, a bellows type spring fixed, at one end thereof, to the spring support, a seal ring holder fixed to the other end of the bellows type spring, and a rotary seal ring held by the seal ring holder, the rotary seal ring providing the annular rotary seal face.

The compact mechanical seal may further comprise an O-ring fitted between the sleeve and the rotary shaft.

The compact mechanical seal may further comprise a wedged copper packing fitted between the stationary seal ring and the oil seal cover.

The compact mechanical seal may further comprise a wedged copper packing fitted between the sleeve and the rotary shaft.

Each of the seal faces may be made of carbon, silicon carbide, or tungsten carbide.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating a compact mechanical seal according to an embodiment of the present invention;

FIG. 2 is an enlarged sectional view illustrating a rotary seal part of the compact mechanical seal shown in FIG. 1;

FIG. 3 is a sectional view illustrating a compact mechanical seal according to another embodiment of the present invention;

FIG. 4 is an enlarged sectional view illustrating a seal structure of a rotary seal part of the compact mechanical seal shown in FIG. 3; and

FIG. 5 is a sectional view illustrating a conventional oil seal.

### DESCRIPTION OF THE PREFERRED EMBODIMENTS

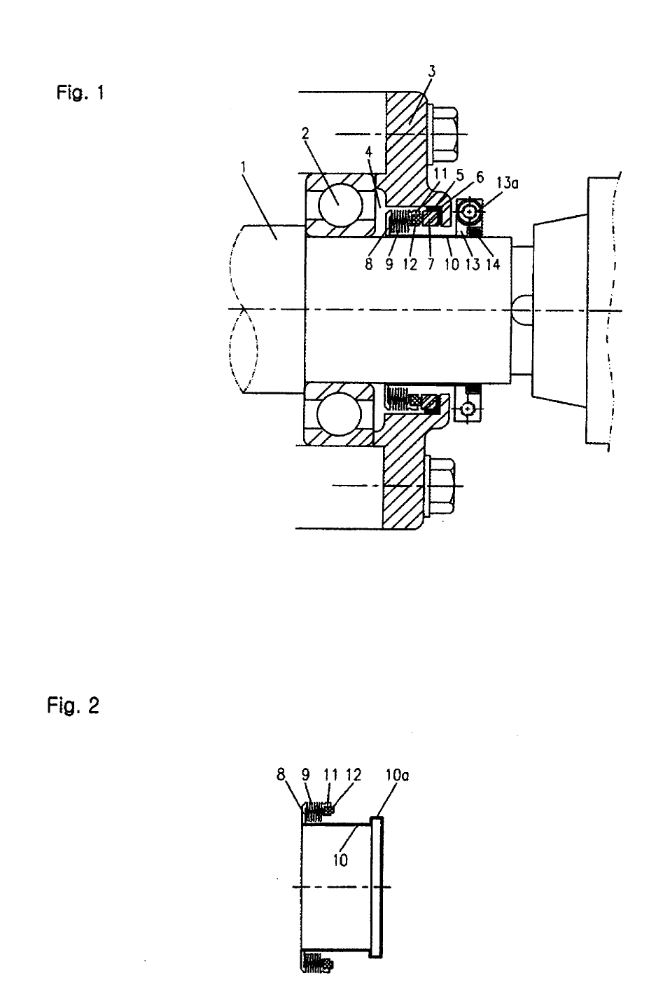

Referring to FIG. 1, a compact mechanical seal according to an embodiment of the present invention is illustrated.

As shown in FIG. 1, the compact mechanical seal includes a stationary seal part fitted around a rotary shaft 1 such that the stationary seal part is maintained in a stationary state when the rotary shaft 1 rotates, and a rotary seal part fitted around the rotary shaft 1 such that the rotary seal part is rotated together with the rotary shaft 1 when the rotary shaft 1 rotates.

The stationary seal part of the compact mechanical seal includes an oil seal cover 3 mounted to a bearing housing fitted around the rotary shaft 1, a rubber packing 6 fixed to an inner surface of the oil seal cover 3, and a stationary seal ring 7 fixed to the rubber packing 6. The stationary seal ring 7 provides an annular stationary seal face.

The rotary seal part includes a sleeve 10 tightly fitted around the rotary shaft 1, a spring support 8 fixed to one end of the sleeve 10 (a left end in FIG. 1) by means of welding, and a bellows type spring 9 fixed, at one end thereof, to the spring support 8 by means of welding. The bellows type spring 9 may be formed using a thin stainless steel plate.

The rotary seal part also includes a seal ring holder 11 fixed to the other end of the bellows type spring 9 by means of welding, and a rotary seal ring 12 inserted into the seal ring holder 11 such that the rotary seal ring 12 is firmly held by the seal ring holder 11. The rotary seal ring 12 has an annular rotary seal face.

The stationary seal ring 7 and rotary seal ring 12 are made of a material exhibiting high anti-wear properties, for example, carbon, silicon carbide (SiC), or Tungsten carbide.

As shown in FIG. 2, the sleeve 10 has an annular groove 10a formed at the other end of the sleeve 10 (a right end in FIG. 2). An O-ring is fitted in the annular groove 10a, to seal a gap defined between the sleeve 10 and the rotary shaft 1.

In order to assemble the stationary and rotary seal parts respectively having the above-described structures, the rotary seal part is first fitted around the rotary shaft 1 at a region where a sealing effect should be provided due to installation of a bearing 2, namely, near a bearing housing. In this case, the rotary seal part is arranged such that the seal face of the rotary seal ring 12 is opposite to the bearing 2. Thereafter, the stationary seal part is fitted around the rotary shaft 1 such that the stationary seal part encloses the rotary seal part in a space 4, and is then fastened to the bearing housing. At this time, the stationary seal part is arranged such that the seal face of the stationary seal ring 7 is in close contact with the seal face of the rotary seal ring 12. In this state, bolts 13a are fastened to a sleeve fixing ring 13, to fasten the sleeve fixing ring 13, and thus, to fix the sleeve 10 to the rotary shaft 1. Accordingly, the rotary seal part is fixed to the rotary shaft 1. Thus, the assembly of the stationary and rotary seal parts is completed.

In the assembled state of the mechanical seal, the seal face of the rotary seal ring 12 in the rotary seal part is in close surface contact with the seal face of the stationary seal ring 7 in the stationary seal part in a state of being elastically pressed against each other by virtue of the spring force of the bellows type spring 9.

When the rotary shaft 1 rotates, the sleeve 10 is rotated together with the rotary shaft 1 because the other end of the sleeve 10 is fixed to the rotary shaft 1 by the sleeve fixing ring 13. In accordance with the rotation of the sleeve 10, the rotary seal ring 12 slidably rotates on the stationary seal ring 7. Since the seal face of the rotary seal ring 12 is in close surface contact with the seal face of the stationary seal ring 7 in a state of being elastically pressed against each other by virtue of the spring force of the bellows type spring 9, as described above, no oil leakage occurs between the seal faces during rotation of the rotary seal part with respect to the stationary seal part. Also, there is no oil leakage between the gap defined between the sleeve 10 and the rotary shaft 1 by virtue of the O-ring fitted in the annular groove 10a of the sleeve 10.

In FIG. 1, reference numeral 5 designates a U-shaped groove formed at the oil seal cover 3 to receive the rubber packing 6.

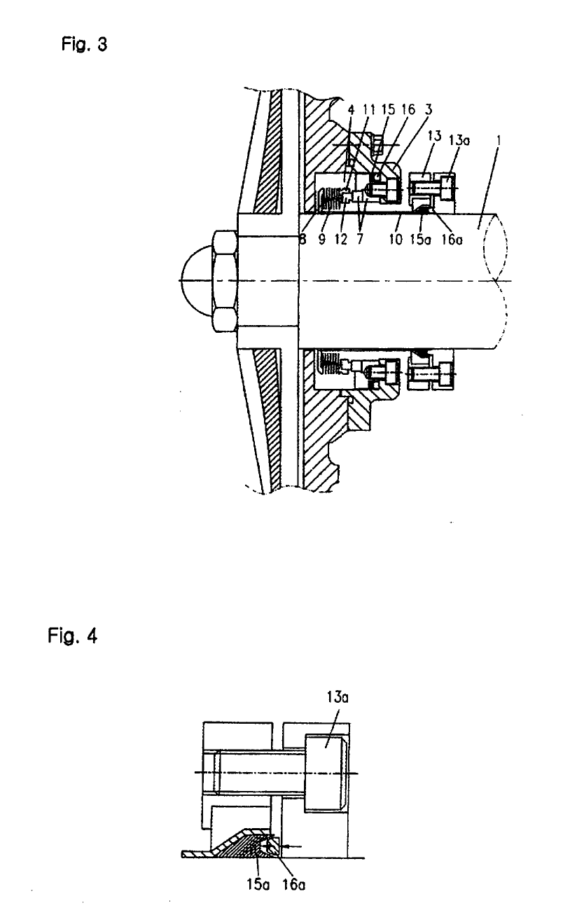

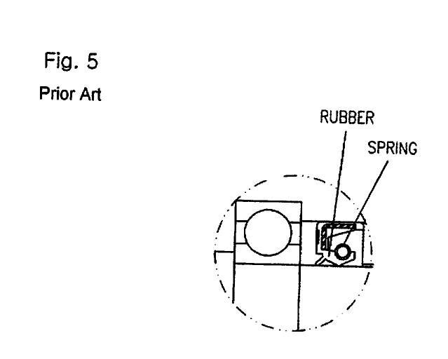

Referring to FIG. 3, a compact mechanical seal according to another embodiment of the present invention is illustrated. This embodiment is applied to the case in which the mechanical seal should withstand high pressure and high temperature, as compared to the above-described embodiment.

The mechanical seal of FIG. 3 is similar to that of FIG. 1, except that it includes a structure capable of withstanding high pressure and high temperature. In FIG. 3, constituent elements respectively corresponding to those in FIG. 1 are designated by the same reference numerals.

In accordance with this embodiment, a copper packing 15 is interposed between the oil seal cover 3 and the stationary seal ring 7, to provide a sealing effect. The copper packing 15 is provided with a wedge groove for receiving a wedge 16, in order to obtain an increased sealing effect. As shown in FIG. 4, another copper packing 15a is fitted in an annular groove formed at the right end of the sleeve 10, in order to provide a sealing effect. Similarly to the copper packing 15, the copper packing 15a is provided with a wedge groove for receiving a wedge 16a, in order to obtain an increased sealing effect.

As apparent from the above description, in the compact mechanical seal having the above-described configuration, no oil leakage occurs during rotation of the rotary shaft because the seal face of the rotary seal ring is in close surface contact with the seal face of the stationary seal ring in a state of being elastically pressed against each other by virtue of the spring force of the bellows type spring. Since the seal rings are made of a material exhibiting high anti-wear properties, there is no or little wear of the seal rings. Also, the O-ring, which is installed to seal the gap defined between the sleeve and the rotary shaft, does not frictionally contact with the rotary shaft, so that it is not worn. Accordingly, the mechanical seal of the present invention can be reliably used for a prolonged period of time. In addition, the mechanical seal has a compact structure by virtue of the use of the bellows type spring, so that it can be installed in a limited space. As a result, the manufacturing costs of a pump or other machines, to which the mechanical seal of the present invention is applied, can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A compact mechanical seal comprising:
a stationary seal part fitted around a rotary shaft such that the stationary seal part is maintained in a stationary state when the rotary shaft rotates, the stationary seal part having an annular stationary seal face; and
a rotary seal part sealably fitted around the rotary shaft such that the rotary seal part is rotated together with the rotary shaft when the rotary shaft rotates, the rotary seal part having an annular rotary seal face being in close contact with the stationary seal face of the stationary seal part in a state of being elastically pressed against each other during the rotation of the rotary shaft.

2. The compact mechanical seal according to claim 1, wherein the stationary seal part comprises:
an oil seal cover mounted to a bearing housing fitted around the rotary shaft;
a rubber packing fixed to an inner surface of the oil seal cover; and
a stationary seal ring fixed to the rubber packing, the stationary seal ring providing the annular stationary seal face.

3. The compact mechanical seal according to claim 2, wherein the rotary seal part comprises:
a sleeve tightly fitted around the rotary shaft;
a spring support fixed to one end of the sleeve;
a bellows type spring fixed, at one end thereof, to the spring support;
a seal ring holder fixed to the other end of the bellows type spring; and
a rotary seal ring held by the seal ring holder, the rotary seal ring providing the annular rotary seal face.

4. The compact mechanical seal according to claim 3, further comprising:
an O-ring fitted between the sleeve and the rotary shaft.

5. The compact mechanical seal according to claim 3, further comprising:
a wedged copper packing fitted between the stationary seal ring and the oil seal cover.

6. The compact mechanical seal according to claim 5, further comprising:
a wedged copper packing fitted between the sleeve and the rotary shaft.

7. The compact mechanical seal according to claim 1, wherein each of the seal faces is made of carbon, silicon carbide, or tungsten carbide.
